(19) United States
(12) Patent Application Publication
(10) Pub. No.: US 2015/0169675 A1
(43) Pub. Date: Jun. 18, 2015

(54) DATA ACCESS USING VIRTUAL RETRIEVE TRANSFORMATION NODES

(71) Applicants: Bare Said, Sankt Leon-Rot (DE); Frank Jentsch, Mühlhausen (DE); Frank Brunswig, Heidelberg (DE)

(72) Inventors: Bare Said, Sankt Leon-Rot (DE); Frank Jentsch, Mühlhausen (DE); Frank Brunswig, Heidelberg (DE)

(73) Assignee: SAP AG

(21) Appl. No.: 14/109,494

(22) Filed: Dec. 17, 2013

(51) Int. Cl. G06F 17/30

(52) U.S. Cl. CPC G06F 17/30424

(57) ABSTRACT

Systems and methods are disclosed for accessing data. The method may include receiving at runtime, a retrieve request for data associated with a node of a business object data model. Based on a set of attributes for at least one business object associated with the business object data model, a virtual retrieve transformation node (VRTN) may be generated at runtime. The VRTN may use a set of data from a metadata repository. The requested data may be retrieved at runtime using the generated VRTN. The set of attributes may be received from a plurality of available sets of attributes generated statically, during design time analysis. During runtime analysis, the available sets of attributes may be modified based on attributes requested during runtime.

### BACKGROUND

As enterprises accumulate ever-greater amounts of data on their transactions, processes, products, and operations, online analytical processing has become an essential part of doing business. The number of tools and techniques addressing analytical processing has grown, enabling data analysts to quickly analyze and navigate through vast and complex collections of data using business process software and platforms. Business process software systems use business objects to represent real-world items used during the transaction of business. For example, a business object may include business logic and/or structured data, and may be used to represent a business document, such as a sales order, a purchase order, an invoice, a product, a business partner, or equipment. The underlying structure of the business object may be determined based on the requirements of the business environment in which the business object is to be used.

The business process software and platforms use business objects, which include attributes (or information) that may be spread across many business objects nodes and many different databases. In many instances, business applications access and process semantically-close business data, which is spread over several nodes belonging to the same or to different business objects. However, when such semantically-close business data is spread over several nodes, there may be performance drawbacks resulting from redundant access of the data by business process software and platforms.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

In an example aspect of the disclosure, a computing system may be adapted to perform a method for accessing data. The method may include generating, using a metadata repository, a plurality of attribute sets. Each attribute set may include one or more access paths for accessing node data. At runtime, a retrieve request may be received for data associated with a node of an object model (e.g., business object metadata object model, metadata object model for user interface or Web service). An attribute set may be retrieved from the plurality of attribute sets. The retrieved attribute set of attributes may be associated with the node data of the object model. The requested data may be retrieved using a virtual retrieve transformation node. The virtual retrieve transformation node may be associated with the retrieved attribute set. At least some of the plurality of attribute sets may be modified based on at least one of a plurality of attributes that are expected to be requested at the runtime.

As described herein, a variety of other features and advantages can be incorporated into the technologies as desired.

### BRIEF DESCRIPTION OF THE DRAWINGS

FIG. 1 is a block diagram of an exemplary system for accessing information content using a data access optimizer, in accordance with an example embodiment of the disclosure.

FIG. 2 is a flowchart for accessing data within the system of FIG. 1.

FIG. 3 is an example data structure with data accessible through multiple core service invocations, which may be used in accordance with an example embodiment.

FIG. 4A is a block diagram of an example metadata repository supporting data access analysis, in accordance with an example embodiment of the disclosure.

FIG. 4B is a block diagram illustrating attribute superset creation, which may be used in accordance with an example embodiment.

FIG. 4C is a block diagram of an example business object metadata object model.

FIG. 5 is a block diagram of an integrated data access optimizer, in accordance with an example embodiment of the disclosure.

FIGS. 6-8 are flowcharts illustrating methods for accessing data using virtual retrieve transformation nodes, in accordance with example embodiments of the disclosure.

FIG. 9 is a diagram of an exemplary computing system, in which described embodiments can be implemented.

### DETAILED DESCRIPTION

### Example 1

### Exemplary Overview

Redundancy-free business objects are an important aspect in developing extensible cloud business applications and ensuring data integrity and data consistency. In some instances, performance drawbacks, which may occur in business applications when semantically-close business data are spread over several nodes belonging to the same or to different business objects, may be overcome using retrieve transformation nodes (or RTNs). As used herein, the term “retrieve transformation node” refers to a node that may be used to provide fast access to specific data sets of a business object, and may be composed of data of other nodes of the same business object or different business objects.

Retrieve transformation nodes, however, may lack flexibility for continuously adapted or extended business applications. In this case, data may be accessed using virtual retrieve transformation nodes (or VRTNs) as described herein. More specifically, a VRTN may be generated automatically at runtime when business object data is accessed. Additionally, the VRTN may support an optimized auto-prefetching of semantically-close business data. The VRTN may be generated based on runtime and design time data access analysis. During design time data access analysis, supersets of attributes may be created based on the attribute structure of business objects associated with possible data retrieve requests. During the runtime data access analysis, the supersets of attributes may be modified based on information about attributes that have been requested (and are expected to be requested again) for the business objects associated with data retrieve requests. A VRTN may then be generated at runtime based on the modified attribute superset, and the VRTN may be used to access and retrieve requested data at runtime. In this regard, the VRTN enables the runtime engine to avoid a cascaded retrieval of data chunks and also enables it to avoid the execution of multiple join operations subsequently to data retrieval. Additionally, the VRTN generation may be transparent to the client or the consumer that invokes the core services (resulting in the data retrieve request) and, therefore, there may be no need for any adaption on the client side to obtain the performance optimization when business object data is accessed using VRTNs.

As used herein, the terms “data” or “information content” (or “InfoContent”) can include analytics data, such as created analytics reports, analytics, or other artifacts created by enterprise database suites (e.g., SAP's Crystal Reports, Lumira Datasets, WEBI reports, XCelcius reports, etc.). The data or information content can also be other, arbitrary content such as spreadsheets, images, user interfaces, web services, or the like.

As used herein, the term “database connection” (or simply a “connection”) can include the connection established between a client device (e.g., an access terminal) and one or more database servers (i.e., database repositories) hosting at least one database. In this regard, a “database connection” may include information identifying a database (e.g., a server address and logon properties of a database), information identifying a subset of a database (e.g., fields, calculations, filters, groupings, or the like), information identifying a database query (or simply a “query”), and/or information identifying a data cube (or simply a “cube”) (such identifying information may include a server address and a technical name of a cube). Each of the database connections may be associated with one or more fields, which may be used to further distinguish and/or classify the information content for a given database connection.

As used herein, the term “business object” may represent real-world items used during the transaction of business, such as business documents (e.g., a sales order, a purchase order, an invoice, etc.), a product, a business partner, a piece of equipment, and so forth. A business object may include business logic and/or data having any suitable structure, which may be based on the requirements of the business scenario in which the business object is to be used. For example, a business object (or a user interface for rendering data for business objects, or a web service for accessing data for business objects) may include a plurality of attributes (or data), where the attributes may be associated with access paths to the locations (e.g., database locations) storing the attributes' data. Each attribute may be associated with one or more backend data processing services used for querying, retrieving and manipulating the data.

As used herein, the term “metadata object model” (or “meta object model”) may include information defining the structure (e.g., header structure, child nodes structure, node associations, etc.) of a business object, a user interface, and/or a web service, for example.

As used herein, the term “metadata” means data about other data, and the term “analytics metadata” can include metadata associated with information content, as well as metadata associated with one or more locations hosting the information content. For example, for a given analytics report, the “analytics metadata” may include metadata associated with the report itself (e.g., title, author, date of creation, report fields, report columns, linked information sources, and the like), as well as metadata associated with the database connection for the analytics report (e.g., metadata associated with a database, a database query and/or a data cube used for accessing or hosting the analytics report). Additionally, analytics metadata for one category of database connections (e.g., a database) may be associated (e.g., linked) to analytics metadata associated with another database connection category (e.g., a query and/or a cube), and/or to analytics metadata associated with information content that is accessible via the database connection. Furthermore, analytics metadata may include information for one or more attributes (or data) associated with a meta object model as well as the access path (e.g., location to a node, a database or another data location) for accessing data associated with the attribute.

The disclosed technologies may be used by data analysts during the creation of information content. For example, analytics metadata associated with the information content may be used to search for a database connection using a keyword, and then rank the database connections based on a match between the keyword and various categories of analytics metadata for the database connection. After the database connections are ranked and a connection is selected, a search of the fields associated with the selected database connection may be performed. The search of the fields may also be based on a match between the keyword and various categories of analytics metadata associated with the fields for the selected database connection. The fields may then be ranked and a field may be selected based on the ranking.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

### Example 2

### Exemplary System for Accessing Information Content Using a Data Access Optimizer

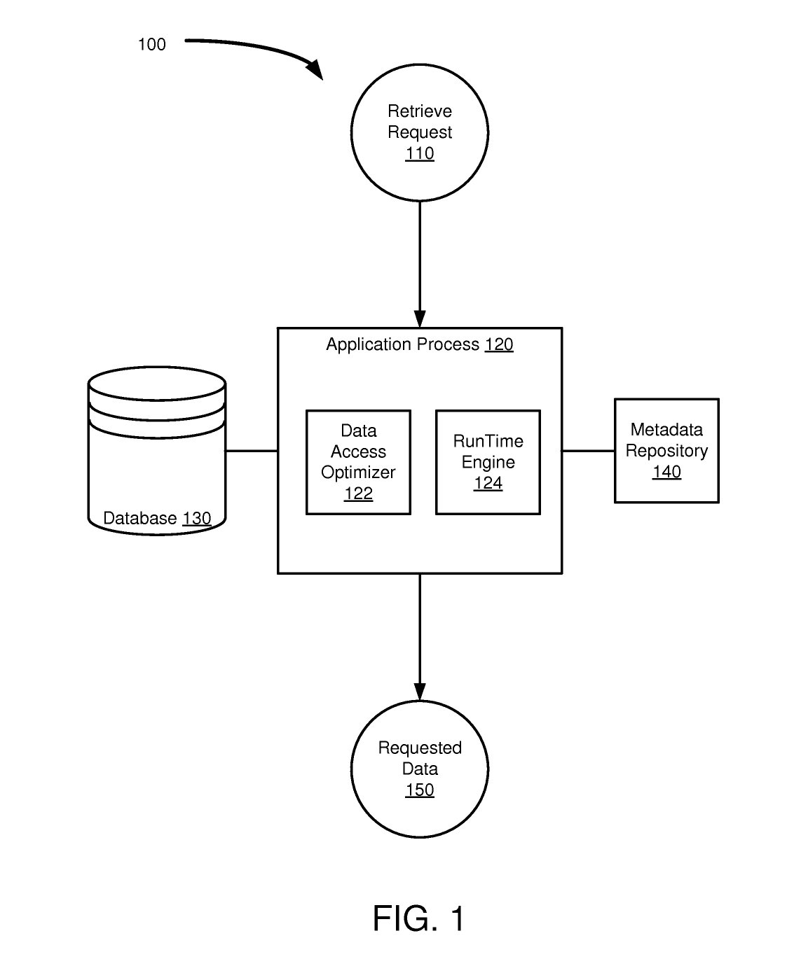

FIG. 1 is a block diagram of an exemplary system for accessing information content using a data access optimizer, in accordance with an example embodiment of the disclosure. Referring to FIG. 1, the exemplary system 100 may comprise an application process 120, a database 130 and a metadata repository 140. The application process 120 may be running on an application server, and may implement a data access optimizer 122 and a runtime engine 124.

The data access optimizer 122 may comprise suitable circuitry, logic, and/or code and may be operable to perform design time data access optimization, runtime data access optimization, and VRTN generation. The design time data access optimization may use information stored in the metadata repository 140 to generate a superset of attributes for each business object (individual business object or combination of business objects) that is being serviced by the application process 120. The superset of attributes may include the attributes associated with a given business object. In some instances, the metadata repository 140 may also include additional metadata associated with attribute popularity (certain attributes are used most of the time by a plurality of users of the business objects), user settings (access to certain attributes may be limited by an end user setting) and so forth. In this regard, the data access optimizer 122 may monitor (e.g., during runtime) core service invocations (or core service calls) for the business objects, user interfaces and/or system interfaces (e.g., web services), and may determine which attributes are requested and how often. Additionally, the application process 120 may use an application programming interface (API) with an external server (e.g., the server dispatching the retrieve request 110) to obtain information on the attributes that will be requested at runtime from the currently active business object(s) (and/or such information may be directly communicated to the application process 120 via the retrieve request 110). In this case, the superset of attributes may be limited using the additional metadata so as to include only a portion of the attributes associated with the business object. The superset of attributes may be stored in the database 130.

The runtime data access optimization of the data access optimizer 122 may be performed during runtime and may include modifying a superset of attributes based on the attributes that have been (and are expected to be) requested during runtime.

In operation, business object core data services may be invoked (e.g., at a client terminal) and a retrieve request call 110 may be generated and dispatched to the application process 120. The retrieve request 110 may be associated with data needed by a currently active business object, user interface, or a web service. The retrieve request 110 may also include information identifying the attributes that are currently active and available to (or accessible by) the user.

The runtime engine 124 may receive the retrieve request 110 and may trigger the data access optimizer 122 (e.g., via a plugin) to generate the VRTN based on the intercepted retrieve request 110. The data access optimizer 122 generates a VRTN using node data and its associated access path based on a superset of attributes for the currently active business object (e.g., associated with a currently active user interface screen), where the superset may have been previously modified based on runtime analysis. The runtime engine 124 may then use the VRTN to get requested data 150 associated with the VRTN, where the data may have been pre-fetched. In this regard, the requested data 150 may be output for use by one or more core services invoked by the currently active business object, without the need for processing the core service implementations separately (and without the need to fetch the VRTN node data separately).

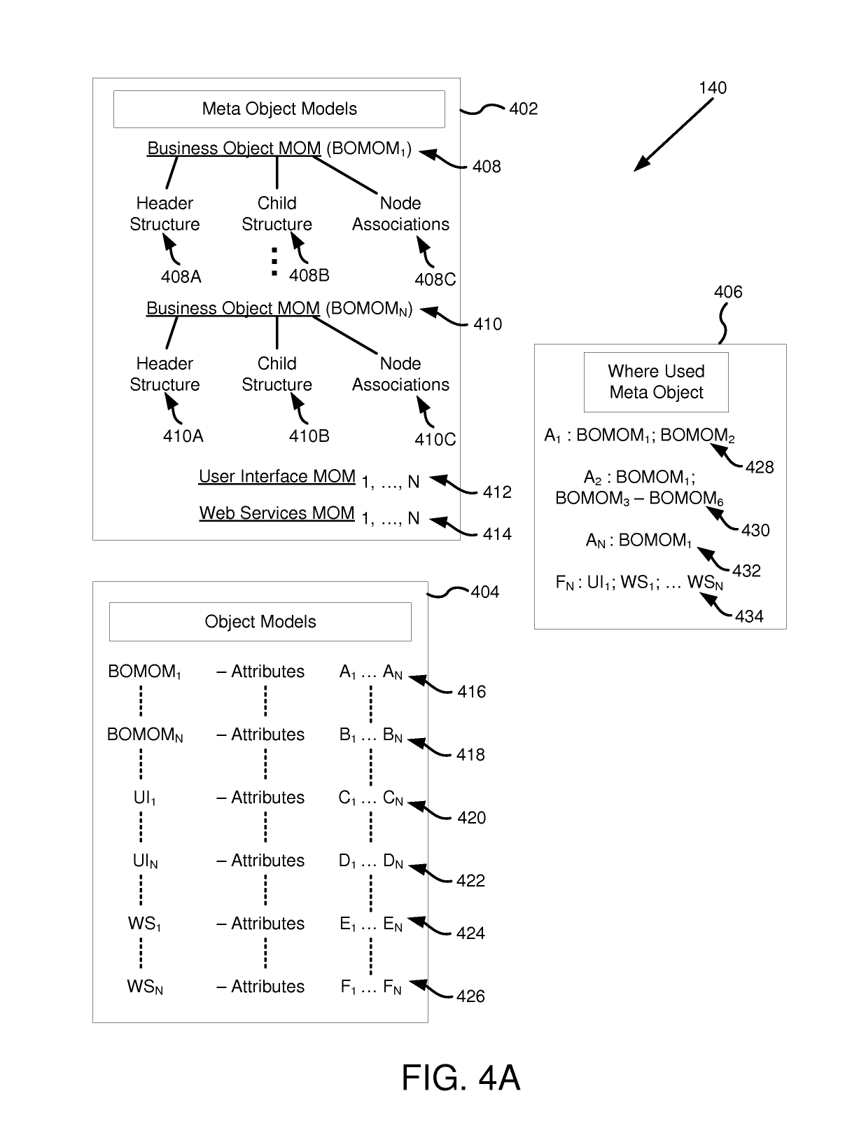

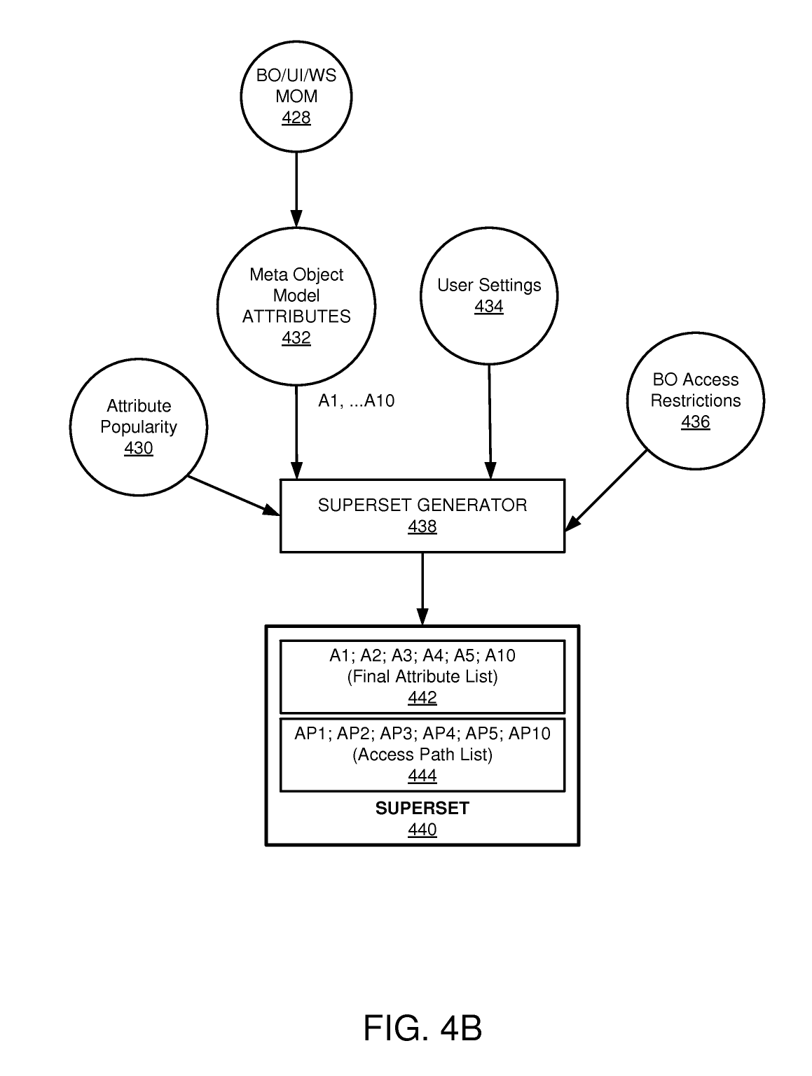

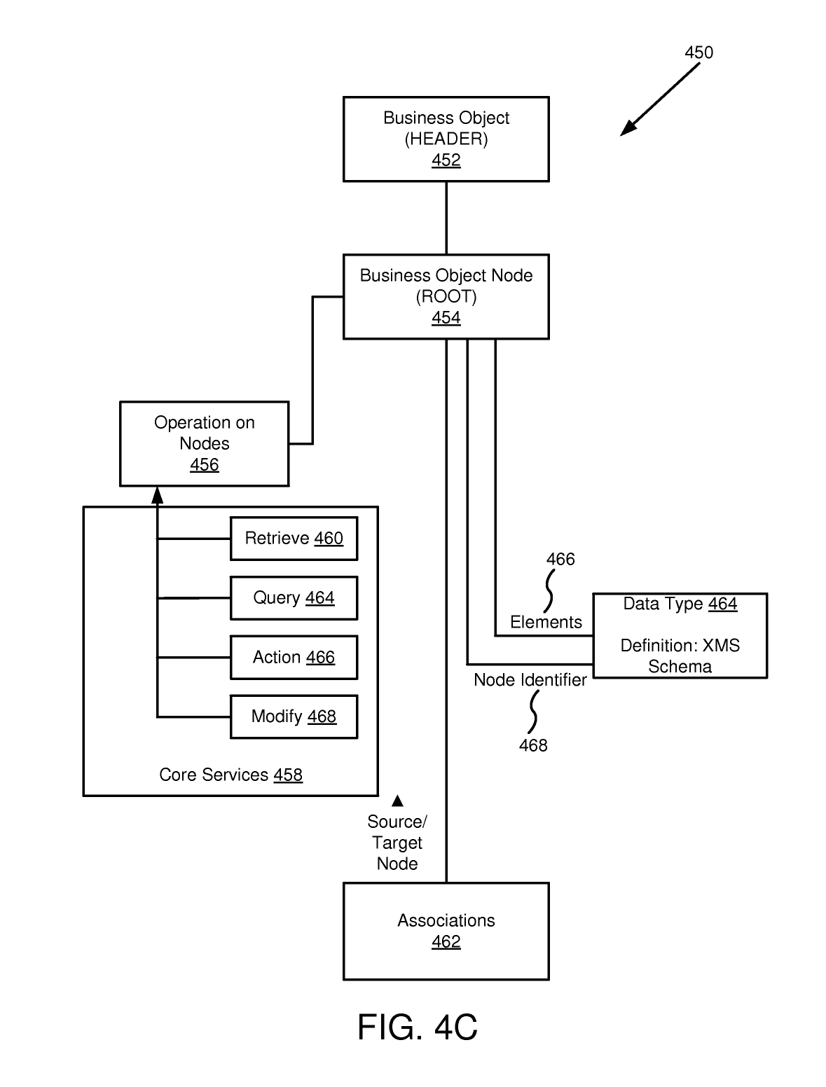

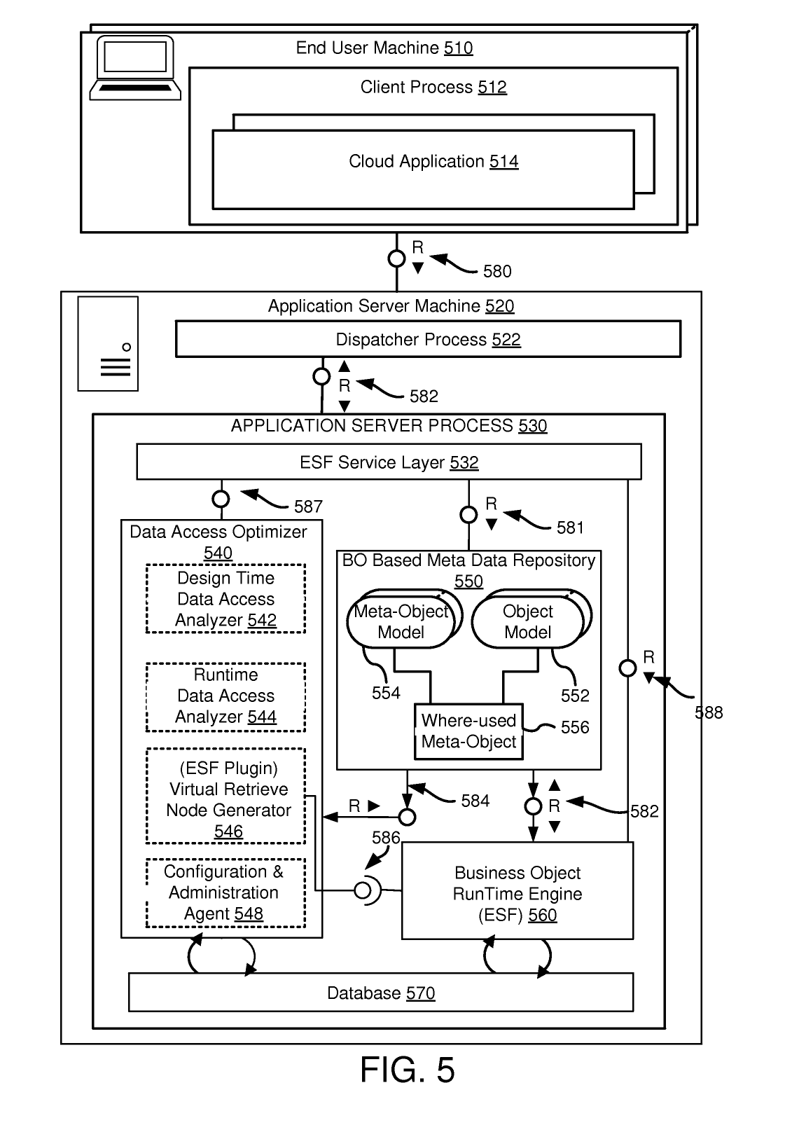

The created VRTN will be most efficient in instances when the currently active business object invokes a chain of dependent core services associated with data requests, and the data requests match the pre-fetched data using the VRTN, so that no further data accesses or join operations may be needed. In instances when a subsequent core service call in a currently active business object does not match the pre-fetched data associated with the VRTN (e.g., a user invokes an attribute not currently active or present in the VRTN), the intercepted retrieve request call 110 may be processed completely in its original implementation (and without using the VRTN) to respond adequately to the client request. In this instance, a data mismatch may be logged during runtime data access analysis, and the superset of attributes for the currently active business object may be updated to include the newly requested attribute. In this regard, continuous optimization of the attribute supersets may be performed, resulting in continuous improvement of the data access optimizer 122. Additional detailed information on the data access optimizer 122 and other components of the application process 120 is discussed in reference to FIGS. 4A-5 below.

### Example 3

### Exemplary Flowchart for Accessing Information Content Using a Data Access Optimizer

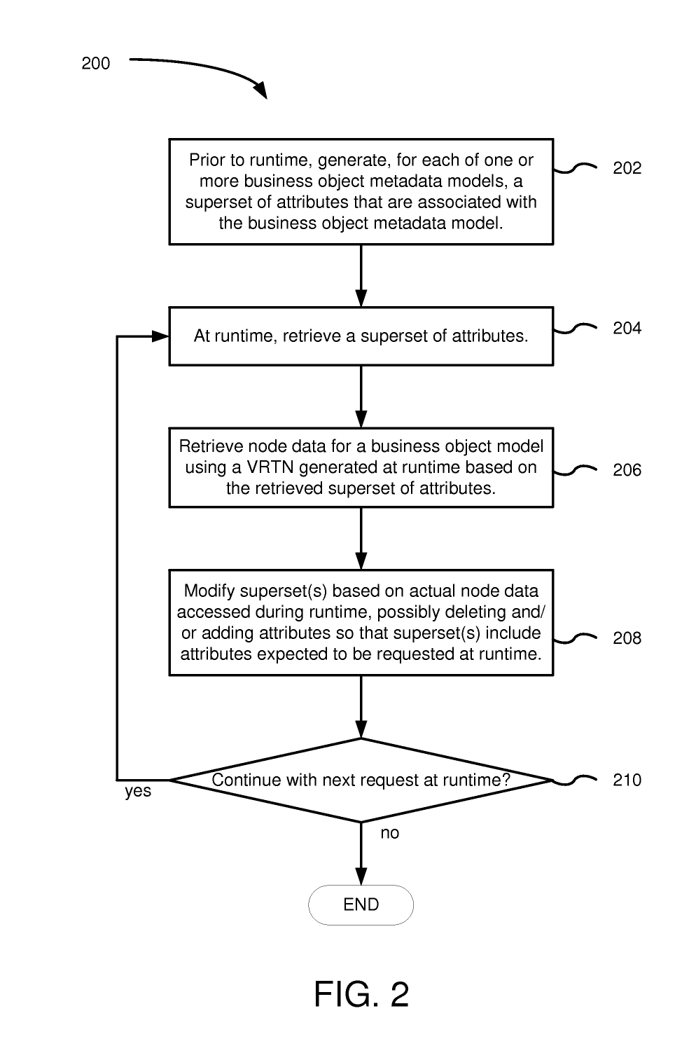

FIG. 2 is a flowchart for accessing data within the system of FIG. 1. Referring to FIG. 2, the example method 200 may start at 202, when one or more supersets of attributes may be generated by the application process 120 using the metadata repository 140. A given superset of attributes may be associated with an object model specified by the metadata repository 140. The superset(s) of attributes may be generated statically, prior to runtime, and may be generated for all meta object models in the metadata repository 140, a subset of all available meta object models, or for a specific meta object model (or even a specific business object).

At 204, a retrieve request 110 may be received by the application process 120 at runtime. A superset of attributes associated with the currently active business object may be retrieved. At 206, the runtime engine 124 may use the data access optimizer 122 to generate a VRTN using the retrieved superset of attributes (e.g., associated with the currently active business object). Node data 150 may then be requested using the VRTN.

In instances when the retrieve request 110 relates to data that was not associated with a superset of attributes, then one of the superset(s) of attributes may be modified (or updated) at 208 to include attributes associated with the actual node data requested (e.g., an attribute may be added or deleted from a superset, so that the superset includes the attributes that are expected to be requested during runtime). At 210, the application process checks whether to continue with another request at runtime, which might be serviced using a VRTN based on a modified superset of attributes.

### Example 4

### Example RTN and VRTN for Accessing Information Content

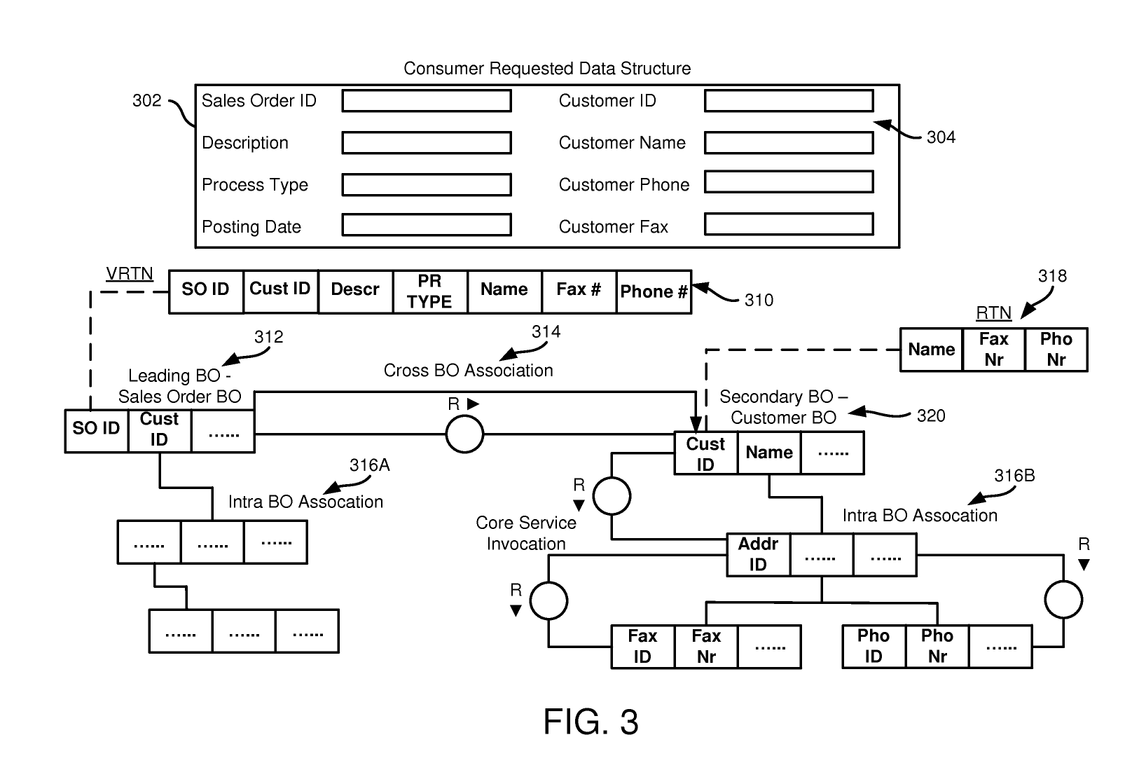

FIG. 3 is an example data structure with data accessible through multiple core service invocations, which may be used in accordance with an example embodiment. Referring to FIG. 3, there is illustrated a user interface 302, which may be associated with a metadata object model. The user interface 302 may include a plurality of attributes 304 (in the illustrated example, the user interface 302 includes eight attributes). A user may access the user interface 302 to access and retrieve data associated with, for example, one or more business objects, such as a sales order business object 312 and a customer business object 320. In this example, a user may be provided with navigational and data access options relating to sales orders in a business system, and the user may interact with the user interface 302 to enter, edit or view data associated with different sales orders. In an example embodiment, some of the data elements that make up the sales order business object 312 may include data that may be retrieved using an RTN or VRTN to increase processing efficiency.

As shown, for example, the sales order business object (or BO) 312 may invoke cross BO association 314 to access data in a secondary BO, such as the customer BO 320. More specifically, for a Customer ID attribute, the sales order BO 312 may need to invoke cross BO association (or call) 314 to customer BO 320, as well as intra BO associations (e.g., 316B) to access and retrieve BO node data for the attributes associated with customer name, phone and fax number.

In an example embodiment, an RTN 318 may be generated when data sets of a business object (such as the sales order business object 312 or the customer BO 320) are frequently accessed via multiple screens or forms but are spread over several business objects. The RTN 318 may be generated so that it provides access to specific attributes, such as the name, fax and phone number attributes. In other instances (e.g., when more flexibility is desired), a virtual RTN 310 may be created and used to retrieve node data for the user interface 302. More specifically, the VRTN 310 may be generated using design time and runtime data access optimization, as described herein. For the example illustrated in FIG. 3, the VRTN 310 includes all attributes 304 used by the user interface 302, except the “posting date” attribute, which has been restricted out of the VRTN 310 because of, for example, a setting making that attribute unavailable. Data associated with the attributes in the VRTN 310 may be pre-fetched and, when requested, communicated back to the user, without the need to invoke any service calls to business objects for accessing and retrieving the attribute data associated with the VRTN 310. In this regard, intra-BO associations (e.g., 316A and 316B), as well as cross-BO associations (e.g., 314), may be avoided and processing efficiency may be increased.

### Example 5

### Example Metadata Repository Used in VRTN Generation

FIG. 4A is a block diagram of an example metadata repository supporting data access analysis, in accordance with an example embodiment of the disclosure. Referring to FIG. 4A, there is illustrated an example structure of a metadata repository (such as the repository 140) supporting data access analysis and retrieving of data using VRTNs. More specifically, the metadata repository 140 may comprise a meta object models (MOMs) portion 402, an object models portion 404, and “where used meta object” portion 406.

The meta object models portion 402 may comprise information characterizing (or describing) the header node structure (e.g., 408A, . . . , 410A), child node structure (e.g., 408B, . . . , 410B), and node associations (e.g., 408C, . . . , 410C) for each of a plurality of business object meta object models (e.g., 408, . . . , 410). Additionally, the meta object models portion 402 may also comprise information characterizing the structure of one or more user interfaces (e.g., 412) and one or more web services (e.g., 414).

The object models portion 404 may include information identifying attributes (and associated access paths) 416, . . . , 418, 420, . . . , 422, 424, and 426 for business object MOMs 408, . . . , 410, user interfaces 412 (e.g., UI₁, . . . , UI_{N}) and web services 414 (e.g., WS₁, . . . , WS_{N}), respectively.

The “where used meta object” portion 406 may include information on which attributes are used in which accessing objects (e.g., screen or user interface element), how many times, how often, and so forth. For example, the “where used meta object” portion 406 may indicate that attribute A₁ is used in business object meta object model (BOMOM) 1 and BOMOM₂ (as indicated by reference number 428). Similarly, attribute A₂ is used in BOMOM₁ and BOMOM₃-BOMOM₆, and so forth, as indicated by reference numerals 430, . . . , 434, and attribute FN is used in MOMs for certain user interface and Web service objects.

### Example 6

### Attribute Superset Generation

FIG. 4B is a block diagram illustrating attribute superset creation, which may be used in accordance with an example embodiment. Referring to FIG. 4B, the superset generator 438 may comprise suitable circuitry, logic, and/or code and may be operable to generate one or more attribute supersets used to generate VRTNs in accordance with technologies described herein. The superset generator 438 may be implemented by, for example, the data access optimizer 122 (or as a separate functionality within the application process 120).

In operation, a business object, user interface, or a web service meta-object model 428 may be identified. Based on the identified meta object model 428, the superset generator 438 may use the metadata repository 140 to retrieve the meta-object attributes 432 associated with the identified meta object model 428. For example, the superset generator 438 may retrieve attributes A1, . . . , A10 from the metadata repository during a design time data access optimization. The superset generator 438 may then generate an attributes superset 440 including the identified attributes A1, . . . , A10. In addition to the identified attributes, the superset 440 may also include access path information identifying access paths for the attributes A1, . . . , A10.

The superset 440 may be further modified (e.g., during runtime and using runtime data access optimization techniques disclosed herein) to include a final attribute list 442 and associated access path list 444. For example, the superset generator 438 may receive attribute popularity information 430 (e.g., from the “where used meta object” portion 406, or based on logged request data), user settings information 434 (relating to settings that are currently for a active business object, user interface or web service), and access restriction information 436 (e.g., identifying certain attributes that the user has no access to). The additional information 430, 434, 436 may be used during runtime data access optimization to modify the attributes superset generated during design time data access optimization. The modified attributes superset 440 may then be used for generating of a VRTN associated with the attributes (and access paths) identified by the superset 440. In an example instance, the node data associated with the attributes in the VRTN (and the superset 440) may be accessed and retrieved using SQL SubQueries or other data access techniques.

### Example 7

### Example Business Object Metadata Object Model

FIG. 4C is a block diagram of an example business object metadata object model. Referring to FIG. 4C, the business object MOM 450 may comprise header structure information 452 and information regarding one or more root (or child) nodes or structures 454. Each root structure 454 may also comprise information identifying operations 456 that are allowed on the root structure 454. For example, the operations 456 on nodes may include core services 458. The core services 458 may specify one or more of a retrieve operation 460, a query operation 464, an action operation 466, and a modify operation 468.

The business object MOM 450 may further include associations 462, which may define the associations between the object having the root node 454 and other objects such as child objects. The business object MOM 450 may also specify data type 464 for each of a node identifier 468 and node elements 466 associated with a given root node 454.

### Example 8

### Integrated Data Access Optimizer for Generating VRTNs

FIG. 5 is a block diagram of an integrated data access optimizer, in accordance with an example embodiment of the disclosure. Referring to FIG. 5, an end user machine 510 may be running a cloud application 514 as part of information content-related client process 512. The end user machine 510 may be coupled to an application server machine 520.

The application server machine 520 may comprise a dispatcher process 522 and an application server process 530. The dispatcher process 530 may comprise suitable circuitry, logic, and/or code and may be operable to communicate one or more received data retrieve requests (e.g., 580) to the application server process 530 using communication path 582.

The application server process 530 may comprise a service layer 532, a data access optimizer 540, a metadata repository 550, a runtime engine (e.g., an enterprise service framework, or ESF) 560, and a database 570. The metadata repository 550 may comprise a meta-object model portion 554, an object model portion 552 and “where used meta-object” portion 556, which have functionalities as described herein in reference to FIG. 4A. The service layer 532 may provide one or more APIs for exposing services provided by the application server process 530 to the dispatcher process 522.

The data access optimizer 540 may comprise suitable circuitry, logic, and/or code and may be operable to perform design time data access optimization, runtime data access optimization, and VRTN generation (e.g., as explained in reference to the data access optimizer 122 in FIG. 1). In this regard, the data access optimizer 540 may comprise a design time data access analyzer (DTDAA) 542, a runtime data access analyzer (RTDAA) 544, a virtual RTN generator 546, and a configuration/administration agent 548.

The DTDAA 542 may comprise suitable circuitry, logic, and/or code and may be operable to interface with the metadata repository 550 to define a potential set of attributes that may be used for generating VRTNs, such as one or more attribute supersets (e.g., 440). In this regard, the DTDAA 542 may use meta-object models (554), object models (552) and associated attribute relationships (e.g., using portion 556) as maintained in the metadata repository 550. The “where used meta-object” portion 556 may deliver to the DTDAA 542 binding information between, for example, user interface elements and business object attributes. Based on the delivered information and on the business object models maintained in the metadata repository 550, the DTDAA 542 may determine a plurality of attributes and/or access paths for such attributes (or sequence of core service invocations) needed to populate the output data structures associated with results returned for a received retrieve request (e.g., 580). The determined access paths and/or attributes may be used as the principal source of information for the generation of attribute supersets and the virtual retrieve transformation nodes.

The design time analysis by the DTDAA 542 is not restricted to the user interfaces, and may also include data retrieved through other data access channels, such as web service access and business objects. In similar manner, web service interfaces and their binding to business objects can be analyzed in order to determine the access paths that may be potentially shortcut with a virtual retrieve transformation node. In addition to determining relevant attributes and their access paths and combining them into an attribute superset, the DTDAA 542 may also utilize other metadata models that are not directly bound to the business objects, but which may be helpful for creating an optimization strategy and cache management strategy such as scoping and business configuration relevant models (e.g., Integration Scenarios, Process Components, etc.).

The runtime data access analyzer (RTDAA) 544 may comprise suitable circuitry, logic, and/or code and may be used as a complementary component to the DTDAA 542. The RTDAA 544 may be used to enhance and improve the determined attribute superset (or the set of virtual retrieve transformation nodes based on the attribute supersets generated by the DTDAA 542). The RTDAA 544 may interface with the runtime engine (or the enterprise service framework) 560 to trace and log the core service call invocations (e.g., the retrieve request 580 received by the ESF 560 via communication paths 582 and 588). In this regard, the RTDAA 544 may collect information that is available at runtime, such as actual requested attributes and core service invocation occurrences for a specific access path. With the collected information, the RTDAA 544 can modify the attribute supersets used to generate VRTNs such that, going forward, more retrieve requests (according to expectations for the system) can be serviced using VRTNs rather than slower, more complicated core service invocations on underlying business objects. With static design time analysis performed by the DTDAA 542, the supersets of attributes that may be accessed are determined; with the dynamic runtime analysis performed by the RTDAA 544, the actual sets of attributes that are typically being requested may be determined. The RTDAA 544 may determine that some access paths are used so infrequently that it is not worth representing them in VRTNs, considering limits on available resources or cache configuration. In this case, VRTNs for such access paths can be avoided, for the sake of reserving resources for VRTNs with more frequently used access paths.

The VRTN generator 546 may be implemented as an ESF plugin (e.g., plugin 586) to the ESF 560. At runtime, as the ESF 560 receives a core service invocation (e.g., via retrieve request 580), the core service invocation may be delegated via the plugin 586 to the VRTN generator 546 for generating a VRTN for accessing the required data. Based on information collected by the DTDAA 542 and the RTDAA 544, the VRTN generator 546 may create a virtual retrieve node to retrieve the requested data for request 580 with an optimized single database access using, for example, SQL SubQueries in lieu of executing a chain of core services in a specific invocation choreography.

In instances when unexpected core service invocations are received via the request 580, such unexpected invocations (or data requests) may lead to failure to generate an appropriate VRTN. For example, an unexpected core service invocation may include a core service which does not belong to any predetermined access path (e.g., the attributes for such service are not present in the generated attribute superset for any VRTN), or a core service which causes modification to read-only data. In such instance when the generated VRTN does not match the core service invocations (or if an appropriate VRTN cannot be generated), the unexpected core service invocation are executed directly and without a VRTN-based shortcut. Additionally, the superset may be updated (e.g., post runtime for the request) with one or more attributes associated with the unexpected service call.

The configuration/administration agent 548 may comprise suitable circuitry, logic, and/or code and may be operable to enable the end user to manage and administer the data access optimizer 540 depending on available system resources, such as available system memory, or to activate/deactivate the VRTN generation for measurement and analysis reasons. For example, an upper limit on number of available VRTNs or memory available for VRTNs may be specified. Or, as another example, business objects (such as master data objects) that are used in metadata object models can be specified.

The application server process may further employ a plurality of communication paths between the various components. For example, communication paths 587 and 581 may be used (e.g., by the end user machine 510 and the client process 512) to manage the data access optimizer 540 and the metadata repository 550, respectively. Communication path 582 may be used by the ESF 560 to communicate with the metadata repository 550. For example, after the ESF 560 receives the retrieve request 580 via path 588 and identifies a currently active business subject based on the received retrieve request, the ESF 560 may communicate with the metadata repository 550 to verify the structure (e.g., the attributes used) by the currently active business object. Communication path 584 may be used for communicating information between the metadata repository 550 and the data access optimizer 540.

The database 570 may be used by the data access optimizer 540 and the ESF 560 for storing/retrieving of RTNs, VRTNs, attribute supersets and/or attribute data. Other modules/processes within the application server machine 520 may also have access to the database 570. Additionally, the database 570 and the metadata repository 550 may be implemented separately from the application server process 530.

### Example 9

### Example Methods for Accessing Data Using VRTNs

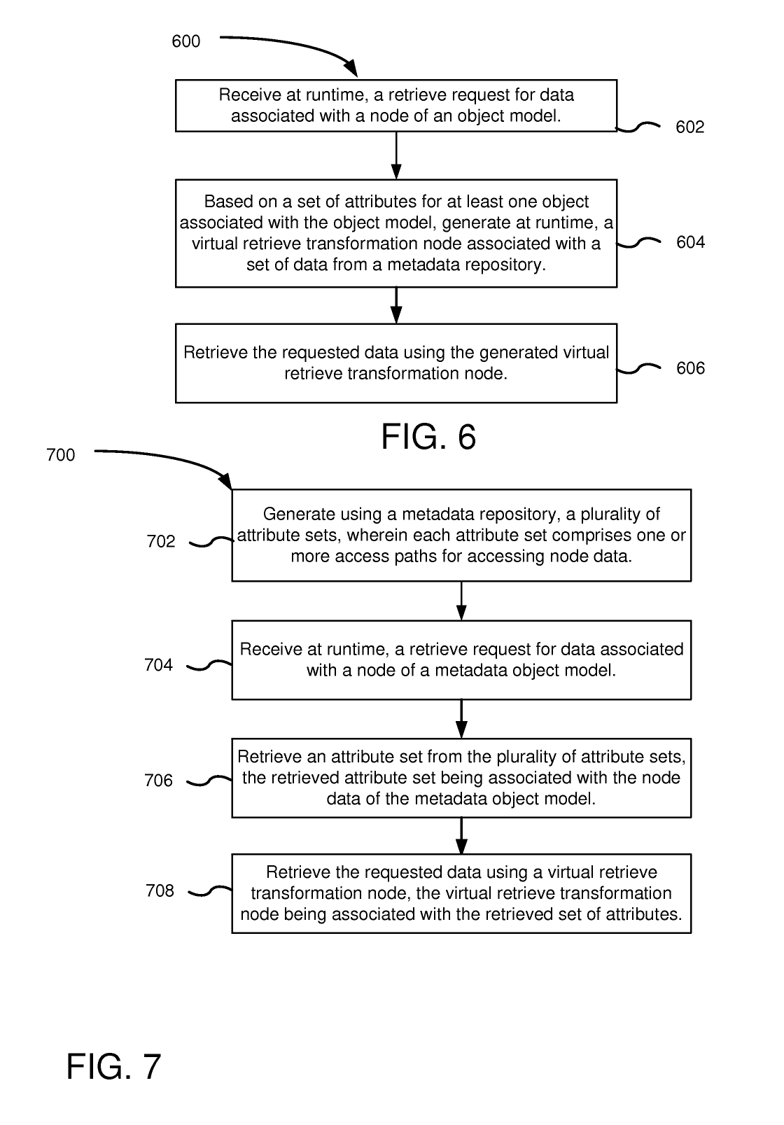

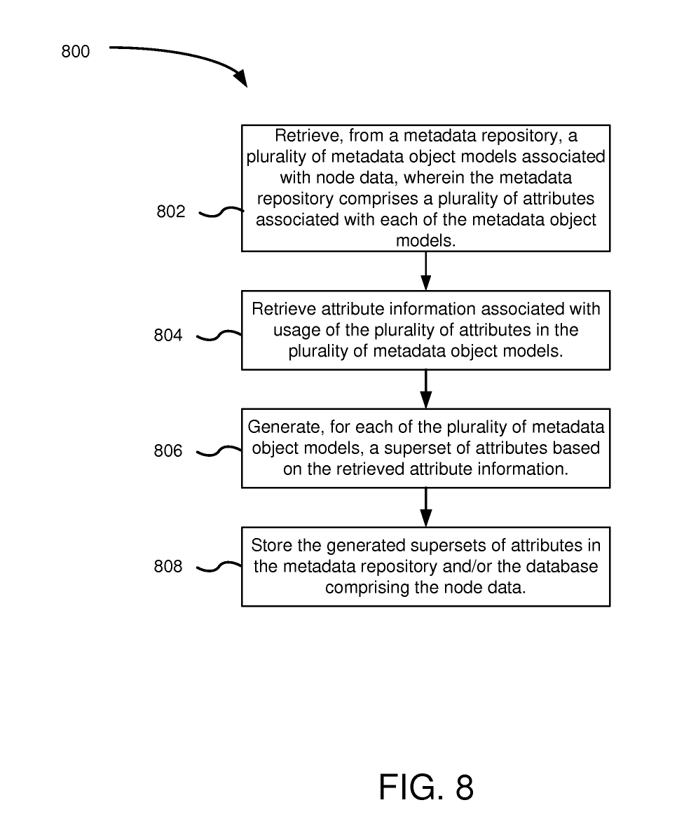

FIGS. 6-8 are flowcharts illustrating methods for accessing data using virtual retrieve transformation nodes, in accordance with example embodiments of the disclosure. Referring to FIGS. 1, 5, and 6, the example method 600 starts at 602 when a retrieve request for data (e.g., 110 or 580) associated with a node of an object model (e.g., metadata object model) may be received at runtime. For example, such request may be received by the application process 120 or 530. At 604, based on a set of attributes for at least one object associated with the object model, a virtual retrieve transformation node associated with a set of data from a metadata repository may be generated at runtime. For example, after the request 580 is received by the ESF 560, the currently active business object may be identified using information in the request 580 and/or information in the metadata repository 550. The DTDAA 542 may have already generated an attribute superset for the identified business object and such superset may be retrieved from the database 570. At runtime, the VRTN generator 546 may generate a VRTN for the currently active business object.

At 606, the requested data may be retrieved (e.g., from the database 570) using the generated virtual retrieve transformation node.

During the runtime processing, in order to generate an appropriate VRTN, the DAO 540 may retrieve a set of attributes from a plurality of available sets of attributes. The set of attributes (e.g., the attribute superset 440) may include at least one access path (e.g., 444) for locating data in the metadata repository or in a database (e.g., 570).

During runtime, the RTDAA 544 may log information about requested attributes (e.g., via analysis of retrieve request 580). The requested attributes may include at least a portion of available attributes associated with the object model. The RTDAA 544 may modify one or more of the available sets of attributes based on the information about requested attributes (e.g., the attributes estimated to be needed/requested).

The modifying performed by the RTDAA 544 may include deleting at least one attribute from an attribute set (e.g., attribute superset 440), if the at least one attribute is not in the information about requested attributes. Also, the sets of attributes (e.g., superset 440) may be modified based on popularity of usage of at least one of the attributes in at least another object that is associated with the object model.

The retrieve request (580) may be received through a user interface based on a selection of a business object by a user interacting with the user interface.

The plurality of available sets of attributes may be generated using at least one set of attributes for each of a plurality of business objects stored in the metadata repository 550. The generating of the plurality of available sets of attributes may be performed by the DTDAA 542 statically, prior to the runtime. The modifying of the sets of attributes may be performed by the RTDAA 544 dynamically, during the runtime.

Referring to FIGS. 1, 4B, 5 and 7, the example method 700 starts at 702, when a plurality of attribute sets (e.g., attribute supersets 440) may be generated (e.g., by the DTDAA 542) using a metadata repository (e.g., 550). Each attribute set may include one or more access paths (e.g., 444) for accessing node data (e.g., associated with attributes in the final list 442). At 704, a retrieve request (580) for data associated with a node of a metadata object model may be received at runtime. At 706, the ESF 560 or the DAO 540 may retrieve an attribute set (e.g., attribute superset 440) from the plurality of attribute sets. The retrieved attribute set may be associated with the node data of the metadata object model. The VRTN generator 546 may then generate a VRTN based on the retrieved set of attributes. At 708, the ESF 560 may retrieve the requested data using the generated VRTN that is associated with the retrieved set of attributes.

During the disclosed processing, at least one data structure associated with the node data may be accessed using at least one of the one or more access paths upon occurrence of a core service invocation. The core service invocation may be associated with retrieval of data for at least one of a user interface and a system interface (e.g., running on the end user machine 510).

The application process 530 may monitor a plurality of core service invocations to determine a plurality of requested attributes at runtime. The DAO 540 may modify at least one of the plurality of attribute sets depending on results of the monitoring (e.g., attributed that are expected to be requested at runtime). In instances when the plurality of requested attributes at the runtime are not represented in any available attribute set, an attribute set may be modified to include at least one attribute requested at runtime and not yet associated with any virtual retrieve transformation node. The attribute set so modified may be stored in the database 570, for use in subsequent generation of virtual retrieve transformation nodes.

Referring to FIGS. 1, 4A-4B, 5 and 8, the example method 800 starts at 802, when a plurality of metadata object models associated with node data may be retrieved from a metadata repository (e.g., 550). The metadata repository (140 or 550) may include a plurality of attributes (in 404) associated with each of the metadata object models (in 402).

At 804, the DAO 540 may retrieve attribute information (e.g., using 404 and 406) associated with usage of the plurality of attributes in the plurality of metadata object models (e.g., as listed in 406). At 806, the DAO 540 may generate, for each of the plurality of metadata object models, a superset of attributes (e.g., 440) based on the retrieved attribute information. At 808, the generated supersets of attributes may be stored in one or both of the metadata repository (550) and/or the database comprising the node data (e.g., 570). This makes the generated supersets of attributes available for use in generating VRTNS at runtime based at least in part on the generated supersets of attributes.

The generating of the superset of attributes for each of the plurality of metadata object models may be further based on at least one popularity metric for the plurality of attributes, at least one application setting of an application accessing the node data, and/or at least one access restriction on the application accessing the node data.

At runtime, the ESF 560 may access at least some of the node data using at least one of the generated supersets of attributes (e.g., by invoking the VRTN generator 546 using the plugin 586, generating a VRTN and accessing the node data using the VRTN). For example, the VRTN generator 546 may generate, for a given metadata object model of the plurality of metadata object models, at least one virtual retrieve transformation node for accessing the node data for the given metadata object model, based on the superset of attributes for the given metadata object model.

At runtime, the DAO may modify one or both of at least one attribute and at least one access path in the superset of attributes. The at least one virtual retrieve transformation node may include the attributes in the superset of attributes and at least one access path for each of the attributes. The access path may specify a path to a location of the node data associated with a corresponding attribute.

### Example 10

### Exemplary Computing Systems

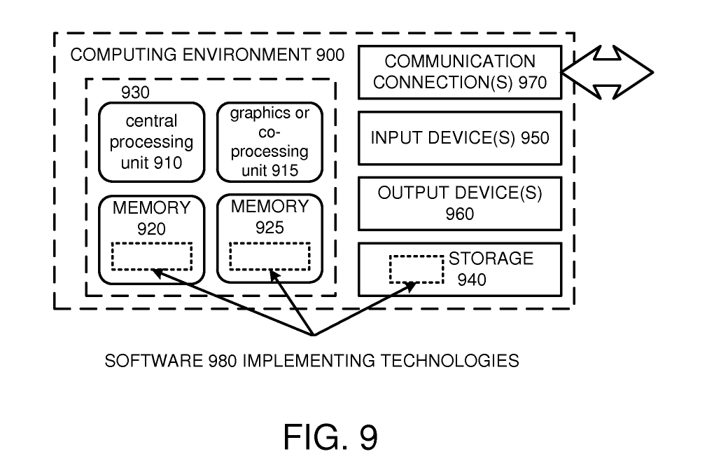

FIG. 9 is a diagram of an exemplary computing system, in which described embodiments can be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 11

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage devices, optical storage devices, or the like). Such instructions can cause a computing device to perform the method. The technologies described herein can be implemented in a variety of programming languages.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A computer-implemented method for accessing data, the method comprising:
receiving, at runtime, a retrieve request for data associated with an object model;
based on a set of attributes for at least one object associated with the object model, generating, at the runtime, a virtual retrieve transformation node; and
retrieving the requested data using the generated virtual retrieve transformation node.

2. The method according to claim 1, wherein the object model is a metadata object model, and wherein the virtual retrieve transformation node is associated with a set of data from a metadata repository, the method further comprising:
retrieving the set of attributes from a plurality of available sets of attributes.

3. The method according to claim 2, wherein the set of attributes comprises at least one access path for locating data in the metadata repository or in a database.

4. The method according to claim 2, further comprising:
logging, during the runtime, information about requested attributes, wherein the requested attributes comprise at least a portion of available attributes associated with the metadata object model; and
modifying, during the runtime, at least one of the plurality of available sets of attributes based on the information about requested attributes.

5. The method according to claim 4, wherein the modifying comprises:
deleting at least one attribute from the at least one of the plurality of available sets of attributes, if the at least one attribute is not in the information about requested attributes.

6. The method according to claim 2, comprising:
modifying at least one of the plurality of available sets of attributes based on popularity of usage of at least one of the attributes in at least another object that is associated with the metadata object model.

7. The method according to claim 2, comprising:
generating the plurality of available sets of attributes by generating at least one set of attributes for each of a plurality of business objects stored in the metadata repository.

8. The method according to claim 7, wherein:
the generating of the plurality of available sets of attributes is performed statically, prior to the runtime; and
the method further comprises modifying at least one of the plurality of available sets of attributes dynamically, during the runtime.

9. The method according to claim 8, further comprising:
receiving, at the runtime, a retrieve request for other data;
based on one of the at least one modified set of attributes, generating, at the runtime, another virtual retrieve transformation node; and
retrieving the requested other data using the generated other virtual retrieve transformation node.

10. The method according to claim 1, wherein the retrieve request is received through a user interface based on a selection of a business object by a user interacting with the user interface.

11. A computing system adapted to perform a method for accessing data, the method comprising:
generating, using a metadata repository, a plurality of attribute sets, wherein each attribute set of the plurality of attribute sets comprises one or more access paths for accessing node data;
receiving at runtime, a retrieve request for data associated with a node of a metadata object model;
retrieving an attribute set from the plurality of attribute sets, the retrieved attribute set being associated with the node data of the metadata object model; and
retrieving the requested data using a virtual retrieve transformation node, the virtual retrieve transformation node being associated with the retrieved attribute set.

12. The system according to claim 11, wherein the retrieving the requested data comprises:
accessing at least one data structure associated with the node data using at least one of the one or more of access paths for the retrieved attribute set upon occurrence of a core service invocation, wherein the core service invocation is associated with retrieval of data for at least one of a user interface and a system interface.

13. The system according to claim 11, wherein the method further comprises:
monitoring a plurality of core service invocations to determine a plurality of requested attributes at the runtime; and
modifying at least one of the plurality of attribute sets depending on results of the monitoring.

14. The method according to claim 11, further comprising:
storing the at least one modified attribute set modified for use in subsequent generation of virtual retrieve transformation nodes.

15. A method for accessing data, comprising:
retrieving, from a metadata repository, a plurality of metadata object models associated with node data, wherein the metadata repository comprises a plurality of attributes associated with each of the metadata object models;
retrieving attribute information associated with usage of the plurality of attributes in the plurality of metadata object models;
generating, for each of the plurality of metadata object models, a superset of attributes based on the retrieved attribute information; and
storing, for use in generating virtual retrieve transformation nodes at runtime based at least in part on the generated supersets of attributes, the generated supersets of attributes in one or both of the metadata repository and a database comprising the node data.

16. The method according to claim 15, comprising:
at runtime, accessing at least some of the node data using at least one of the generated supersets of attributes; and
modifying, dynamically at runtime, one or both of at least one attribute and at least one access path in at least one of the supersets of attributes.

17. The method according to claim 15, wherein the generating of the superset of attributes for each of the plurality of metadata object models is further based on one or more of:
at least one popularity metric for the plurality of attributes;
at least one application setting of an application accessing the node data; and
at least one access restriction on the application accessing the node data.

18. The method according to claim 15, comprising:
at runtime and upon occurrence of one or more core service invocations, generating, for a given metadata object model of the plurality of metadata object models, a virtual retrieve transformation node for accessing the node data for the given metadata object model and associated with the one or more core service invocations, based on the superset of attributes for the given metadata object model.

19. The method according to claim 18, wherein the virtual retrieve transformation node comprises:
the attributes in the superset of attributes for the given metadata object model; and
at least one access path for each of the attributes, wherein the access path specifies a path to a location of part of the node data associated with a corresponding attribute.

20. The method according to claim 18, further comprising:
if, during the runtime, at least one of the one or more core service invocations does not match node data associated with the virtual retrieve transformation node, processing the at least one of the one or more core service invocations without using the virtual retrieve transformation node.
